(19) United States
(12) Patent Application Publication
(10) Pub. No.: US 2007/0044323 A1
(43) Pub. Date: Mar. 1, 2007

(54) Cutter having detachable cutter blade

(76) Inventor: Walley Chao, Taichung (TW)

Correspondence Address: BROWDY AND NEIMARK, P.L.L.C.;624 NINTH STREET, NW, SUITE 300, WASHINGTON, DC, 20001-5303, US

(21) Appl. No.: 11/402,953

(22) Filed: Apr. 13, 2006

(30) Foreign Application Priority Data
Aug. 30, 2005 (TW) 94214955

(51) Int. Cl. B26B 1/00

(52) U.S. Cl. 30/329

(57) ABSTRACT

A cutter includes a handle having a receiving chamber, a positioning device movably mounted in the receiving chamber, a support member mounted inside the receiving chamber, and a cutter blade having a coupling notch coupled to the support member and a locating notch coupled to the positioning device for detachably firmly receiving the cutter blade in the receiving chamber of the handle.

### BACKGROUND OF THE INVENTION

1. Field of the Invention

The present invention relates to a cutter and more particularly, to a cutter having a detachable cutter blade.

2. Description of the Related Art

FIG. 11 is a representative drawing of Taiwan Patent Publication No. 498830 which discloses a handsaw 90. As shown in FIG. 11, the handsaw 90 comprises a handle 91, a saw blade 92, and a lock 93. The lock 93 is mounted in a receiving portion 912 inside the handle 91, comprising a locating plate 94, a press button 95, and two spring members 96 and 97. The locating plate 94 has a through hole 942 and a notch 944. The press button 95 is inserted through the through hole 942 of the locating plate 94 and a round hole 914 at the handle 91. The expanded head of the press button 95 is stopped at the outside wall of the handle 91 around the round hole 914. The spring member 96 is stopped against the notch 944. The spring member 97 is inserted through the through hole 942 to push the press button outwards from the handle 91.

During operation, the user must move the handsaw 90 alternatively backwards and forwards so that the saw blade 92 can cut off the workpiece. However, because the saw blade 92 simply uses a guiding channel 922 and a locating hole 924 for engagement with the locating plate 94 and the press button 95, the saw blade 92 tend to vibrate when cutting the workpiece. In general, this design of handsaw 90 allows the user to replace the saw blade 92; however, the hand saw 90 is not stable in use.

### SUMMARY OF THE INVENTION

The present invention has been accomplished under the circumstances in view. It is one object of the present invention to provide a cutter having a detachable cutter blade, which allows quick replacement of the cutter blade, and keeps the installed cutter blade firmly in position for cutting.

To achieve this object of the present invention, the cutter comprises a handle, a positioning device, a support member, and a cutter blade. The handle has a receiving chamber in one end thereof. The positioning device is movably mounted in the receiving chamber. The support member is mounted inside the receiving chamber. The cutter blade has a coupling notch coupled to the support member, and a locating notch coupled to the positioning device for detachably and firmly receiving the cutter blade in the receiving chamber of the handle.

In a preferred embodiment of the present invention, the support member is a round rod, and the cutter blade is turnable about the support member.

In the preferred embodiment of the present invention, the handle has a through hole in communication with the receiving chamber, a receiving hole corresponding to the through hole, and a post suspending in the receiving hole. In addition, the positioning device comprises a button movably mounted in the through hole of the handle, a stepped bolt stopped against the button, and a spring member mounted on the post and stopped between the handle and the stepped bolt.

Further, the stepped bolt has a head, a shank perpendicularly extending from one side of the head, and an extension axially extending from one end of the shank remote from the head. The head has a diameter greater than the shank. The shank has a diameter greater than the extension.

In the preferred embodiment of the present invention, the locating notch of the cutter blade has a guiding channel and a locating hole in communication with the guiding channel. In addition, the guiding channel has a circularly arched entrance.

### BRIEF DESCRIPTION OF THE DRAWINGS

FIG. 1 is an exploded view of a cutter according to a preferred embodiment of the present invention.

FIG. 2 is a side view of the cutter according to the present invention.

FIG. 3 is a sectional view taken along line 3-3 of FIG. 2.

FIG. 4 is a schematic drawing showing the cutter blade inserted into the receiving chamber of the handle according to the present invention.

FIG. 5 is a schematic drawing showing the cutter blade inserted into the receiving chamber of the handle and the notch of the cutter blade coupled to the support member inside the receiving chamber.

FIG. 6 is a schematic drawing the cutter blade turned about the support member in clockwise direction.

FIG. 7 is a cross sectional view of the present invention, showing the button of the positioning device pressed.

FIG. 8 is a side view showing the cutter used with a long cutter blade according to the present invention.

FIG. 9 is a side view showing the cutter used with a saw blade according to the present invention.

FIG. 10 is a sectional view in an enlarged scale of a part of FIG. 9, showing the positioning status of the saw blade in the handle.

FIG. 11 is an exploded view of a conventional handsaw.

### DETAILED DESCRIPTION OF THE INVENTION

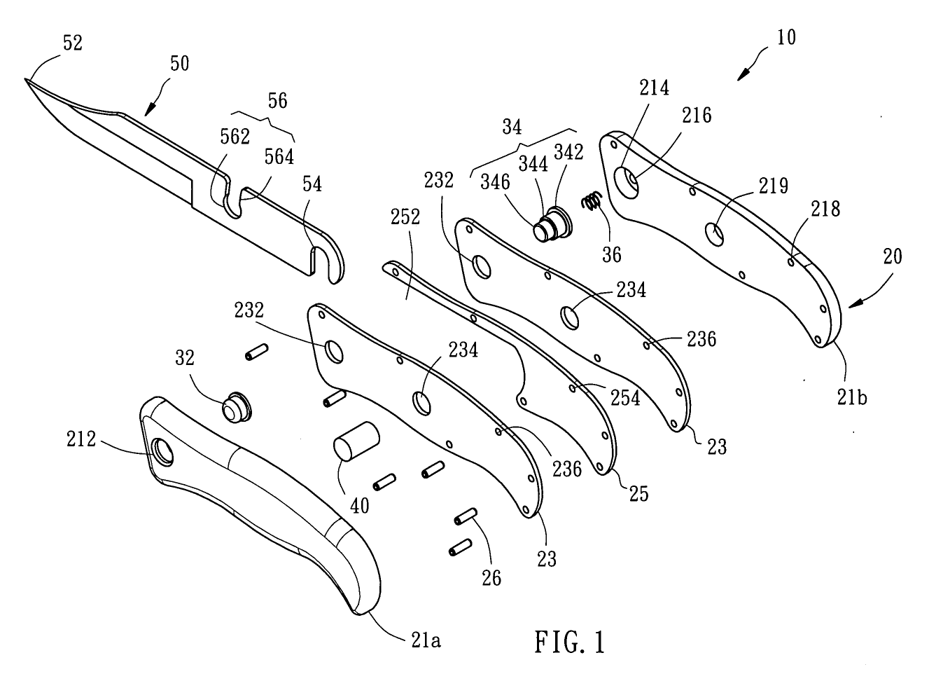

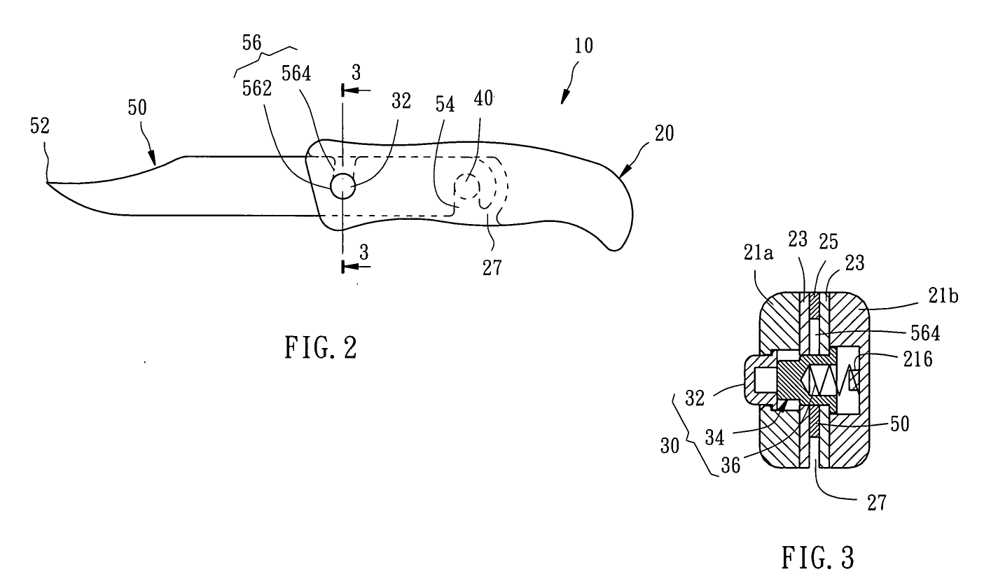

Referring to FIGS. 1-3, a cutter 10 in accordance with the preferred embodiment of the present invention is shown comprising a handle 20, a positioning device 30, a support member 40, and a cutter blade 50.

The handle 20 comprises two grips 21a and 21b, two clamping plates 23, and a middle plate 25. The two grips 21a and 21b have the same shape and are corresponding in location to each other. The grip 21a has a circular through hole 212 cut through the inner and outer sides near the front end. The grip 21b has a circular receiving hole 214 corresponding to the circular through hole 212, and a post 216 suspending in the circular receiving hole 214. The grips 21a and 21b each further have 6 pinholes 218 spaced around the border thereof, and a circular locating hole 219 at the middle thereof. The two clamping plates 23 are set between the grips 21a and 21b and configured subject to the shape of the grips 21a and 21b, each having a wall thickness relatively thinner than the grips 21a and 21b, a first through hole 232 corresponding to the circular through hole 212 and the circular receiving hole 214, a second through hole 234 corresponding to the locating holes 219 of the grips 21a and 21b, and 6 pinholes 236 corresponding to the pinholes 218 of the grips 21a and 21b. The middle plate 25 is set between the two clamping plates 23. The shape and wall thickness of the middle plate 25 are same as the clamping plates 23. However, the middle plate 25 has a front notch 252. The middle plate 25 has also 6 pinholes 254 corresponding to the pinholes 236 of the clamping plates 23. When assembling the handle 20, 6 spring pins 26 are respectively inserted through the pinholes 236 of the clamping plates 23 and the pinholes 254 of the middle plate 25, and then the ends of the spring pins 26 are respectively fixedly fastened to the pinholes 218 of the grips 21a and 21b. When assembled, the front notch 252 of the middle plate 25 defines a receiving chamber 27 in the handle 20.

The positioning device 30 comprises a button 32, a stepped bolt 34, and a spring 36. The stepped bolt 34 has a circular head 342, a cylindrical shank 344 perpendicularly extending from one side of the circular head 42, and an extension 346 axially extending from the one end of the cylindrical shank 344 remote from the circular head 42. The diameter of the circular head 42 is greater than the cylindrical shank 344. The diameter of the cylindrical shank 344 is greater than the extension 346. The button 32 is mounted in the circular through hole 212 of the grip 21a. The shank 344 of the stepped bolt 34 is inserted through the first through holes 232 of the clamping plates 23 with the extension 346 stopped against the button 32. The spring 36 is mounted on the post 261 inside the circular receiving hole 214 and stopped between the bottom wall of the circular receiving hole 214 and a part inside the circular head 342 of the stepped bolt 34 (see FIG. 3). Further, the diameter of the circular head 342 is greater than the first through holes 232 of the clamping plates 23 so that the circular head 342 of the stepped bolt 34 is stopped between the grip 21b and the adjacent clamping plate 23.

The support member 40 according to the present preferred embodiment is a round rod inserted through the second through holes 234 of the clamping plates 23 with the two distal ends thereof respectively fixedly fastened to the locating holes 219 of the grips 21a and 21b.

The cutter blade 50 has a point 52 at the front side, a coupling notch 54 at the rear side, and a locating notch 56. The coupling notch 54 is shaped like a parabolic arch, extending vertically upwards from the bottom edge of the cutter blade 50 for fastening to the support member 40 for enabling the cutter blade 50 to be turned about the support member 40. The locating notch 56 is spaced from the rear side of the cutter blade 50 at about one third of the length of the cutter blade 50. The locating notch 56 includes a locating hole 562 and a guiding channel 564 having a circularly arched entrance. The guiding channel 564 extends downwards from the top edge of the cutter blade 50 and communicates with the locating hole 562 for the mounting of the positioning device 30. Further, the diameter of the locating hole 562 is slightly greater than the width of the guiding channel 564. The width of the guiding channel 564 is slightly greater than the diameter of the extension 346 of the stepped bolt 34. Therefore, the extension 346 of the stepped bolt 34 is movable in the guiding channel 564. The diameter of the locating hole 562 is slightly greater than the diameter of the shank 344 of the stepped bolt 34 so that the shank 344 of the stepped bolt 34 can be positioned in the locating hole 562. Further, the width of the guiding channel 564 is smaller than the diameter of the shank 344 of the stepped bolt 34. Therefore, the stepped bolt 34 of the positioning device 30 can be positioned in the locating hole 562 of the cutter blade 50, thereby preventing the stepped bolt 34 from escaping from the guiding channel 564.

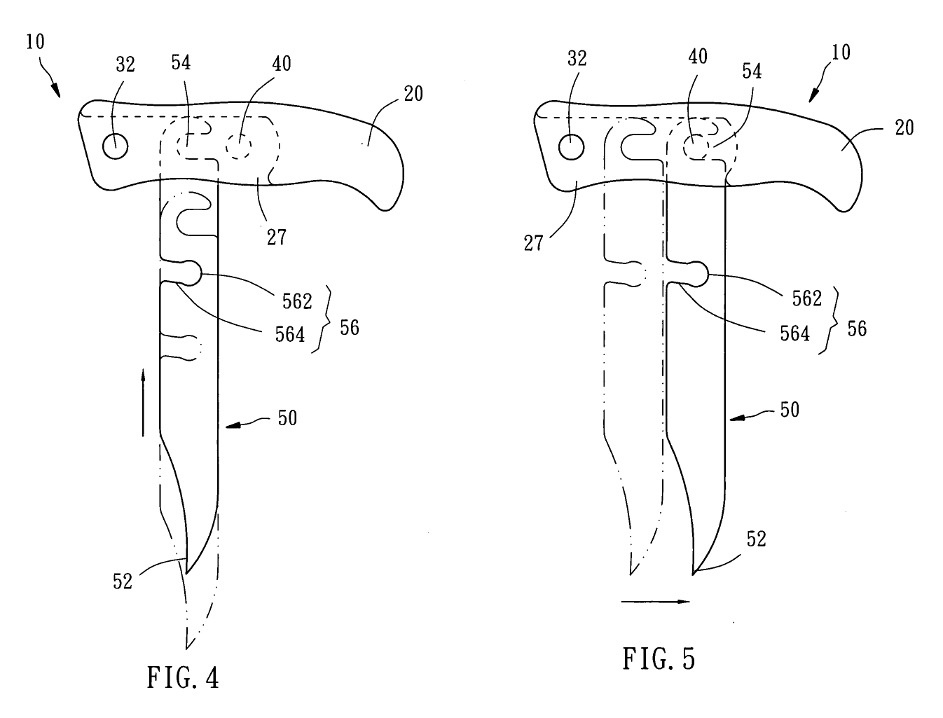

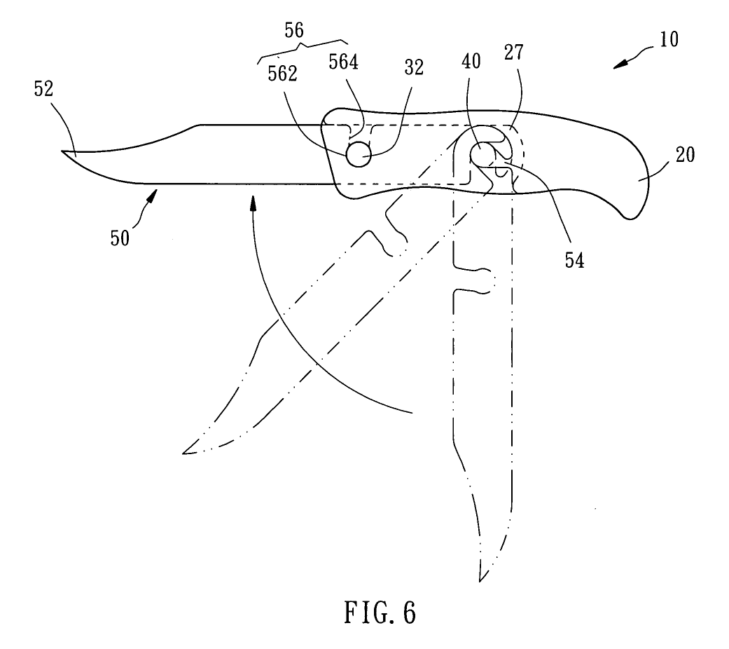

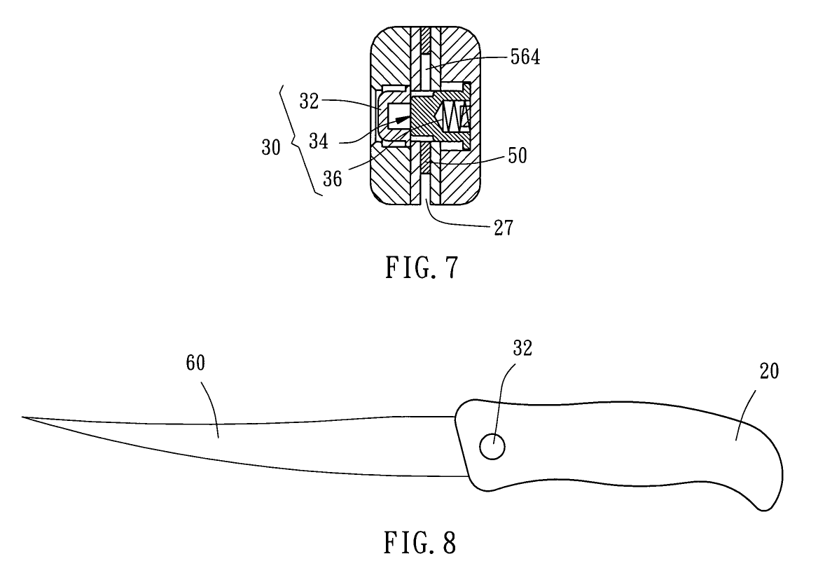

Referring to FIGS. 4-7, when the user wishes to assemble the cutter 10, the user can hold the cutter blade 50 in vertical with the point 52 facing downwards and the notch 54 facing rightwards, and then insert the cutter blade 50 vertically upwards into the receiving chamber 27 of the handle 20, as shown in FIG. 4, and then move the cutter blade rightwards to have the support member 40 be set into the coupling notch 54, as shown in FIG. 5, and then turn the cutter blade 50 clockwise about the support member 40 from vertical to horizontal, as shown in FIG. 6, and then press the button 32, as shown in FIG. 7. Because the guiding channel 564 of the locating notch 56 is smoothly arched at the entrance thereof and has a width slightly greater than the extension 346 of the stepped bolt 34, the extension 346 of the stepped bolt 34 can be smoothly inserted into the locating hole 562. After insertion of the extension 346 into the locating hole 562, the user can release the button 32, thereby enabling the button 32 to be returned to its former position by the spring power of the spring 36. Thus, the shank 344 of the stepped bolt 34 is kept positioned in the locating hole 562. Further, because the width of the guiding channel 564 of the locating notch 56 is smaller than the diameter of the shank 344 of the stepped bolt 34, the stepped bolt 34 of the positioning device 30 is positioned in the locating hole 562 to secure the cutter blade 50 firmly to the receiving chamber 27 of the handle 20. During cutting, the user must move the cutter 10 backwards and forwards so that the cutter blade 50 can cut off the workpiece. However, the positioning device 30 and the support member 40 support the cutter blade 50 firmly against the inside wall of the receiving chamber 27 of the handle 20, thereby preventing vibration of the cutter blade 50 during cutting.

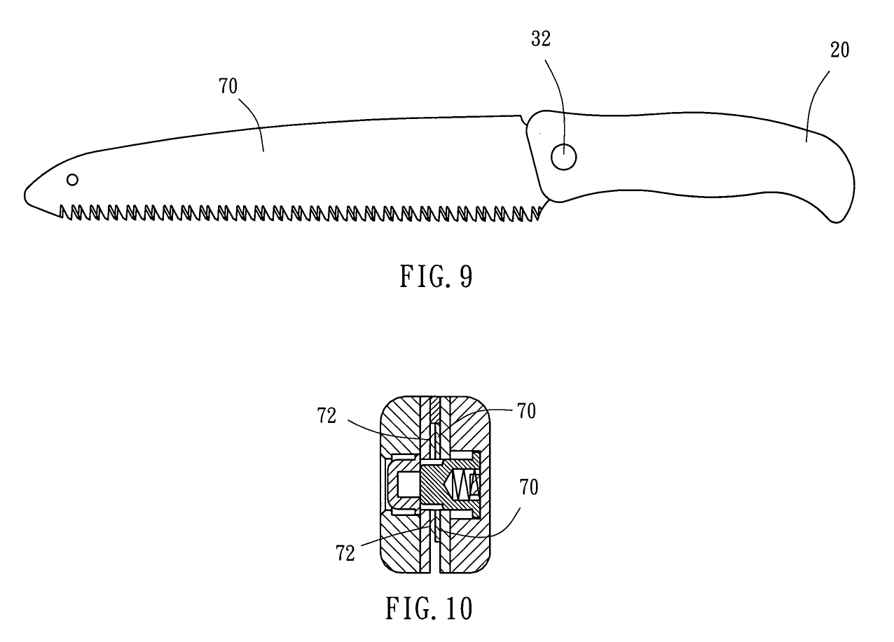

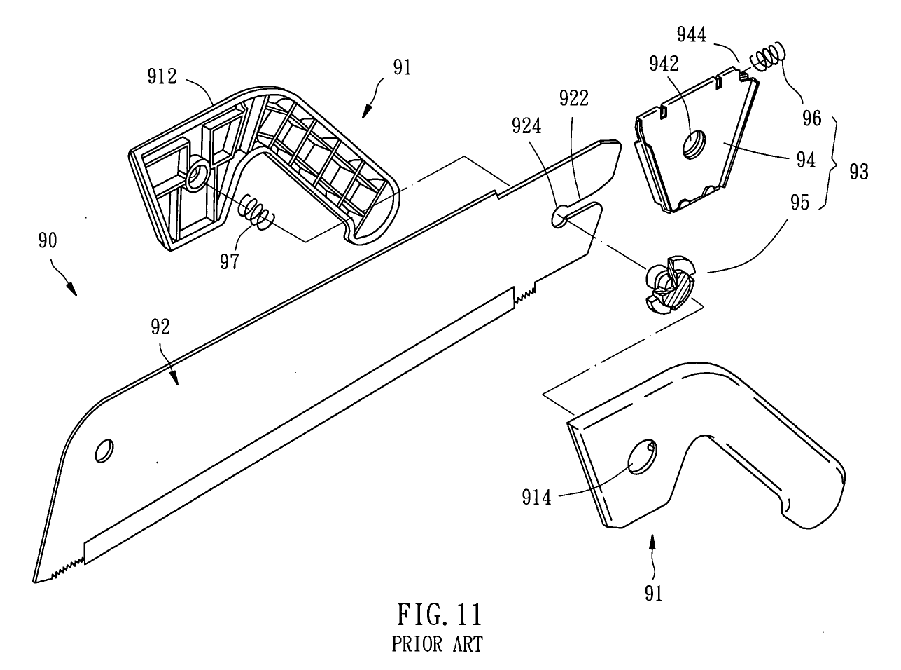

As shown in FIG. 8, when the user wishes to use a long cutter blade 60 to substitute the original cutter blade 50 of FIG. 6, the user can press the button 32 to disengage the cutter blade 50 from the positioning device 30, and then remove the cutter blade 50 from the support member 40, and then install the cutter blade 60 in the handle 20. When wishing to use a saw blade 70 as shown in FIG. 9, the user can press the button 32 to disengage the cutter blade 60 from the positioning device 30, and then remove the cutter blade 60 from the support member 40, and then install the saw blade 70 in the handle 20. Further, as shown in FIG. 10, because the saw blade 70 has a relatively thinner wall thickness, the saw blade 70 is made having two protruding blocks 72 respectively stopped against the handle 70, keeping the saw blade 70 firmly supported in the handle 70.

As indicated above, the invention provides a cutter 10 having a cutter blade 50 that is firmly installable in and easily detachable from the handle. The cutter blade 50 is stopped against the inside wall of the receiving chamber 27 of the handle 20, therefore the cutter 10 is stable in use.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A cutter comprising:
a handle having a receiving chamber in one end thereof;
a positioning device movably mounted in said receiving chamber;
a support member mounted inside said receiving chamber; and
a cutter blade having a coupling notch coupled to said support member, and a locating notch coupled to said positioning device for detachably and firmly receiving said cutter blade in said receiving chamber of said handle.

2. The cutter as claimed in claim 1, wherein said handle has a through hole in communication with said receiving chamber, a receiving hole corresponding to said through hole, and a post suspending in said receiving hole.

3. The cutter as claimed in claim 2, wherein said positioning device comprises a button movably mounted in said through hole of said handle, a stepped bolt stopped against said button, and a spring member mounted on said post and stopped between said handle and said stepped bolt.

4. The cutter as claimed in claim 3, wherein said stepped bolt has a head, a shank perpendicularly extending from one side of said head, and an extension axially extending from one end of said shank remote from said head, said head having a diameter greater than said shank, said shank having a diameter greater than said extension.

5. The cutter as claimed in claim 1, wherein said cutter blade is turnable about said support member.

6. The cutter as claimed in claim 1, wherein said support member is a round rod.

7. The cutter as claimed in claim 1, wherein said locating notch of said cutter blade includes a guiding channel and a locating hole in communication with said guiding channel.

8. The cutter as claimed in claim 7, wherein said guiding channel has a circularly arched entrance.
